(19) United States
(12) Patent Application Publication
(10) Pub. No.: US 2019/0002325 A1
(43) Pub. Date: Jan. 3, 2019

(54) CONTINUOUS SOL-GEL METHOD FOR PRODUCING QUARTZ GLASS

(71) Applicant: D. Swarovski KG, Wattens (AT)

(72) Inventors: Georg Czermak, Wattens (AT); Matthias Gander, Landeck (AT); Christina Streiter, Watttens (AT); Christian Lipp, Vomp (AT); Christian Gabl, Kematen (AT)

(21) Appl. No.: 15/747,251

(22) PCT Filed: Jul. 11, 2016
(86) PCT No.: PCT/EP2016/066439

§ 371 Date: Jan. 24, 2018

(30) Foreign Application Priority Data
Jul. 28, 2015 (EP) 15178593.8

(51) Int. Cl. C03B 19/12; C03B 19/06; C01B 33/12; C01B 33/16

(52) U.S. Cl. CPC C03B 19/12; C03B 19/066; C03B 2201/02; C01B 33/16; C01B 33/126

(57) ABSTRACT

The invention relates to a continuous sol-gel method for producing quartz glass, comprising the following steps:
(a) continuously metering a silicon alkoxide into a first reactor (R1) and carrying out an at least partial hydrolysis process by adding an aqueous mineral acid, thereby obtaining a first product flow (A);
(b) continuously producing an aqueous silicic acid dispersion by continuously mixing water and silicic acid in a second reactor, thereby obtaining a second product flow (B);
(c) continuously mixing the product flows (A) and (B) in a third reactor (R3) in order to produce a pre-sol, thereby obtaining a third product flow (C);
(d) continuously adding an aqueous base to the product flow (C), thereby obtaining a sol;
(e) continuously filling the exiting sol into moulds, thereby obtaining an aquagel;
(f) drying the aquagel, thereby obtaining xerogels; and
(g) sintering the xerogels, thereby obtaining quartz glass, with the proviso that at least one of the steps (a) to (e) additionally includes a degassing process of at least one feed material used in the step.

### FIELD OF THE INVENTION

The invention is in the field of inorganic chemistry and relates to a continuous method for producing quartz glass.

### PRIOR ART

Three-dimensional quartz glass bodies can be produced according to the sol-gel method. The principle of this method is based on an acid or alkali catalysed hydrolysis process and the subsequent gelation of silanes, siloxanes and organosilanes by condensation reactions. In the process, the originally liquid sol transitions into a gel-like state and finally into the solid state via a stable liquid dispersion of nanocrystalline oxide particles. The aquagel obtained in this manner is then dried to form the xerogel and sintered to form quartz glass. The end product is glass-like. Different porosities and morphologies can be adjusted by adding different additives or by the drying regime. In contrast to producing conventional quartz glass in a conventional manner by melting the raw materials at very high temperatures, in the case of the sol-gel method, shaping takes place at room temperature. The glass bodies produced using this technique do not usually need to be reworked, which is both more time-efficient and more cost-effective.

Reactants of a sol-gel synthesis process are low-molecular metal alkoxide compounds. The hydrolysis process of the alkoxides in the presence of an acid or a base is the first step in this synthesis process. Unstable hydroxy compounds (a) are produced as a result of this procedure, which compounds can occasionally oligomerise slightly. The solution produced is a sol. It consists of dispersive polymer particles that are stabilised by their charges. Individual compounds coalesce in a condensation reaction by siloxane bridges (Si—O—Si) being formed (b). This process continues until all the monomers are consumed. A cohesive network is not yet formed. All the resulting particles have a uniform size distribution of a few nanometres under suitable reaction conditions. The reaction speeds of the hydrolysis process and condensation can be influenced by the medium, pH and concentration and occur simultaneously (c). The method has been described in detail by Nogami et al. in Journal of Non-Crystalline Solids, 37, pages 191-201 (1980).

In a suitable environment, a sol can keep for several weeks, sometimes even months. Gelation occurs by condensation in order to form siloxane bonds. The eponymous step of the synthesis process, the sol-gel transition, is reached here. A three-dimensional network has formed from the loose particles of the sol, which network is saturated with the solvent. The sol has become a gel.

After gelation has occurred, the aquagel is dried to form the xerogel. Completely evaporating the solvent results in the entire network being more crosslinked. A compact, highly crosslinked and resistant material results from this step:

M(OR)ₙ+m H₂O−<M(OR)ₙ−ₘ−(OH)ₘ+m ROH (a)

^{˜}M−OH+HO−M^{˜}−>^{˜}M−O−M^{˜}+H₂O (b)

^{˜}M−OR+HO−M^{˜}−>^{˜}M−O−M^{˜}+ROH (c)

$$M = metal \\ ∼ = chemical bonds , preferably three single bonds$$

In the final step, the xerogel is sintered to form the quartz glass.

A plurality of methods are known from the prior art that are concerned with producing quartz glass in general and the sol-gel method in particular.

European patent EP 0131057 B1 (SEIKO) discloses a discontinuous method for producing quartz glass, in which a hydrolysed solution of a metal alkoxide of the formula Me(OR)x is first prepared from which a sol (colloid solution) is formed. After gelating, the sol is dried to form a xerogel. The xerogel is then sintered to form quartz glass.

According to the teaching of European patent EP 0807610 B1 (LUCENT), a method is disclosed for forming a silicon dioxide sol that consists as much as possible of non-agglomerated silicon dioxide, in which method a starting mixture of silicon dioxide particles is produced in water and the silicon dioxide sol is formed from the mixture by shear mixing. An alkaline substance without a metal cation is added to the sol in order to adjust the pH from 6 to 9.

European patent EP 1251106 B1 (FITEL) claims a method in which a sol is provided by mixing silica particles and water, the silica particles having a surface area of from 5 to 25 m²/g and containing at least 85% spherical particulate material, and the weight ratio of the silica particles to water being greater than 65%. The pH is then adjusted to between 10 and 13 by a base and a gelation agent is added to the sol. Tetramethylammonium hydroxide and tetraethylammonium hydroxide are used as the base.

European patent application EP 1258457 A1 (DEGUSSA) discloses a method in which a silicone alkoxide is hydrolysed, to which Aerosil® OX 50, which is used due to its specific properties, its particle size and BET, is then added.

The subject matter of European patent EP 1320515 B1 (DEGUSSA) is a method in which two solutions are produced that are combined to produce a reaction. Solution A is an aqueous acidic dispersion (pH 1.5) of a pyrogenic silica compound (e.g. Aerosil® OX 50). Solution B is an aqueous alkaline dispersion (pH 10.5-13) also of a pyrogenic silica compound (e.g. Aerosil® OX 200). The molar ratio of H₂O to SiO₂ and the molar ratio of the Si compound in solution A to the Si compound in solution B and the resultant pH in mixture C (after the two solutions are combined) is the decisive feature for obtaining three-dimensional bodies that are larger than 2 cm.

European patent application EP 1606222 A1 (DEGUSSA) claims a method in which a sol is produced either from silicone alkoxide or from a silicone alkoxide and a suitable precursor. The sol is subsequently hydrolysed and colloidal silica is then added.

According to European patent application EP 1661866 A1 (EVONIK), an aqueous dispersion is produced from pyrogenic silicon dioxide (colloidal silicon dioxide), the pH of which dispersion is adjusted to from 2 to 0.5 before TEOS is then added. The sol is obtained in this manner and is then is adjusted so as to be alkaline and filled into a mould, where it gelates to form the gel.

European patent application EP 1700830 A1 (DEGUSSA) proposes a method in which an aqueous dispersion of pyrogenic metal oxide is first prepared, to which dispersion a metal oxide is added that was previously hydrolysed by water being added. The sol obtained in this manner is then filled into a mould, where it gelates to form a gel, the water in the aerogel being replaced by an organic solvent.

The subject matter of European patent application EP 1770063 A1 (DYNAX) is a method that is characterised by the use of silicone components that contain both hydrolysable and hydrophobic functional groups; methyltrimethoxysilane is preferred. A pyrolytic compound is also used to influence the microstructure of the gel, which compound may be inter alia formamide. Non-ionic (e.g. polyoxyethylene alkyl ethers, polyoxypropylene alkyl ethers), cationic (cetyltrimethylammonium bromide or chloride) or anionic (sodium dodecyl sulfonates) solvents are used as possible solvents.

The method in European patent application EP 2064159 A1 (DEGUSSA) comprises the following steps: adding pyrogenic silica to the acidic aqueous medium, and then adding silicone alkoxide to the produced dispersion. The molar ratio of silica to silica alkoxide should be from 2.5 to 5 in this case. It is a batch process in which the highly dispersive silicic acid is provided first and then the silica alkoxide is added.

European patent application EP 2088128 A1 (DEGUSSA) proposes a method in which pyrogenic silica is added to acidified water and silicone tetra alkoxide is added to the obtained dispersion. The pH is adjusted again and the mixture is placed into a container, where the sol gelates to form the gel. The gel is then dried to form a xerogel and sintered to form the glass product.

International patent application WO 2013 061104 A2 (DEBRECENI EGYETEM) discloses a continuous method for producing alcogels, aerogels and xerogels, in which silanes are hydrolysed in the presence of alkaline catalysts, a specific aqueous organic solvent system and a gel retarder, and inert particles are introduced into the solution.

EP 2832690 A1 (EMPA). The subject matter of this document is the production of an aerogel, in which process a silicon oxide sol is first produced in an alcoholic solvent, the sol is made to form a gel, a hydrophobing agent is added to the gel and the solvent is then removed by subcritical drying. The sol must contain a hydrophobing agent, such as hexamethyldisiloxane, that can be activated in an acid catalytic manner. In this case, the sol can also be formed continuously in a flow reactor.

GB 2,165,234 A (SUWA). The application from 1984 relates to a batch process for producing doped silicate glass. In the first step, a sol is produced by an alkyl silicate being hydrolysed with ammonia water, for example, and then very finely powdered silicon dioxide or silicic acid being added. A gel is obtained from the sol, which gel is then dried and sintered to form glass. Germanium alkoxides, for example, can be added in any desired step of the method.

US 2003 151163 A1 (WANG). This document relates to a method for removing solvents from the pores of a sol-gel monolith. FIGS. 7 and 8 show a continuous flow reactor that is also supplied with solutions that are in turn continuously produced.

A disadvantage of the discontinuous method of the prior art is that only defined discrete amounts can be produced, which can lead to differences in quality. Producing in batches promotes air bubbles being contained in the glass, which can lead to considerable reductions in quality in the finished sintered products. A further disadvantage is that extensive cleaning of all the systems is required after each pass. Additionally, a continuous method offers simpler possibilities for upscaling.

The object of the present invention consists in remedying the above-described disadvantages. One possibility for doing so consists in carrying out the synthesis process using a continuous method. Any desired quantity of quartz glass of high and consistent quality can be produced as a result.

### DESCRIPTION OF THE INVENTION

The present invention relates to a continuous sol-gel method for producing quartz glass, which comprises the following steps:
(a) continuously metering a silicon alkoxide into a first reactor (R1) and carrying out an at least partial hydrolysis process by adding an aqueous mineral acid, thereby obtaining a first product flow (A);
(b) continuously producing an aqueous silicic acid dispersion by continuously mixing water and silicic acid in a second reactor, thereby obtaining a second product flow (B);
(c) continuously mixing the product flows (A) and (B) in a third reactor (R3) in order to produce a pre-sol, thereby obtaining a third product flow (C);
(d) continuously adding an aqueous base to the product flow (C), thereby obtaining a sol;
(e) continuously filling the exiting sol into moulds, thereby obtaining an aquagel;
(f) drying the aquagels, thereby obtaining xerogels;
(g) sintering the xerogels, thereby obtaining quartz glass, with the proviso that at least one of the steps (a) to (e) additionally includes a degassing process of at least one feed material used in the step.

It has been found that the new continuous method solves all the manifold problems described at the outset simultaneously and comprehensively. Aside from the fact that the method allows the production of any desired quantities of products and therefore also of different quantities of products, the synthesis process leads to products of consistently high quality.

A particularly critical feature of the method of the invention consists in supplying the feed materials of the synthesis process in the degassed condition. Specifically, it has emerged that without this step, dissolved gases are discharged by the mixing as a result of changed solubilities in the reactants and, as explained at the outset, cause bubbles to form. In principle, degassing can occur in each of the method steps (a) to (e), i.e. at the stage of the reactants, the pre-sol, the dispersion or the sol itself. Preferably, the reactants are already degassed and used in the synthesis process in this form. As a precautionary measure, the reactants, the pre-sol, the dispersion or the sol can be degassed.

Degassing is carried out according to the invention preferably using ultrasound. Alternatively, these measures are possible:
Vacuum degassing
Distillation
Vacuum/freezing cycles
Thermal degassing
Chemical methods, such as removing oxygen by chemical bonding;
Removing gas by means of inert gas;
Adding deaerating additives and
Centrifugation or a combination of two or more of these measures.

Additionally, the reactants can optionally be used in a particle-free manner by using suction filters and each mould can be filled with a freshly produced sol. By avoiding rejects that do not conform to specifications, the profitability of the method in particular is thus significantly increased, especially as long cleaning times are dispensed with, in particular as the reactors that are preferably used can be easily cleaned with rinsing agents.

Silicon Alkoxides and Hydrolysis Process (Method Step A)

Silicon alkoxides that are considered within the meaning of the invention to be starting materials for producing quartz glass preferably follow the formula (I)

Si(OR)₄ (I)

in which R denotes an alkyl group having from 1 to 6 carbon atoms. Typical examples are tetrapropyl orthosilicate and tetrabutyl orthosilicate; however, tetramethyl orthosilicate (TMOS) and in particular tetraethyl orthosilicate (TEOS) are preferably used. As TEOS is insoluble in water, alcoholic, specifically ethanolic, solutions can be used, the alcohol functioning as the phase mediator. The silicon alkoxides can also comprise additional silicon compounds as additives, such as methyl triethylsilane, dimethyl diethylsilane, trimethyl ethylsilane and the like.

At this point, additional ionic compounds can also be added to the solution, for example the elements Na, Al, B, Cd, Co, Cu, Cr, Mn, Au, Ni, V, Ru, Fe, Y, Cs, Ba, Cd, Zn, Eu, La, K, Sr, TB, Nd, Ce, Sm, Pr, Er, Tm or Mo, i.e. when dyed quartz glass is desired. However, these compounds can also be added together with the silicic acid or in the course of further steps.

The acidic hydrolysis process of the silicon alkoxides takes place in the reactor R1 in the presence of aqueous mineral acids, such as sulphuric acid, nitric acid, acetic acid or hydrochloric acid. Hydrochloric acid having a concentration of 0.01 mol/l has proved to be particularly favourable. The preferred volume ratio of alkoxide to mineral acid is from 10:1 to 1:10, particularly preferably from 3:1 to 1:3 and more particularly preferably from 2.5:1 to 1:2.5.

The hydrolysis process is carried out at a suitable temperature by the two reactants being conveyed by pumps, merged and reacted in a temperature-controlled flow reactor. If the reactants are unable to mix, a slug flow forms in the flow reactor. The temperature range of the hydrolysis process ranges from 1 to approximately 100° C., the preferred temperature being from approximately 70° C. to approximately 90° C.

Silicic Acids and Production of the Dispersion (Method Step B)

In the second step of the method, an aqueous dispersion of a highly dispersive silicic acid is produced, also continuously, in a temperature-controlled reactor R2. Preferably, the silicic acids have BET surface areas in the range of from approximately 30 to approximately 100 m²/g and in particular from approximately 40 to approximately 60 m²/g. Using the product Aerosil® OX 50 (EVONIK) is particularly preferred, which product is a pyrogenic, hydrophilic silicic acid that has a surface area of approximately 50 m²/g and consists of more than 99.8 wt. % SiO₂. Water and OX 50 are added into a temperature-controlled reactor and homogenised by a dispersing device. The dispersion can be degassed using ultrasonic treatment. The mass proportion of OX 50 in the dispersion is approximately 1-60 wt. %, in particular 33 wt. %. OX 50 and water can be metered gravimetrically, for example.

Formation of Sol (Method Step c)

While a first continuous flow of a hydrolysed silicon alkoxide compound was produced in the first method step and a second flow of an aqueous silicic acid dispersion was produced, also continuously, in the second method step, the two flows are now mixed and the pre-sol is formed in the third step. For this purpose, the product flows (A) and (B) are merged upstream of the reactor R3 by a suitable mixing system. The volume ratios of the two flows (A) and (B) can be variably adjusted. As a result, the product properties of the finished quartz glass can be influenced. A preferred volume mixing ratio is from approximately 10:1 to approximately 1:10, particularly preferably from approximately 5:1 to approximately 1:5 and more particularly preferably from approximately 2.5:1 to 1:2.5. Here, the pre-sol can be degassed, according to the standards of quality of the quartz glass, by suitable degassing methods, for example ultrasound. The product flows (A) and (B) are merged at temperatures of from 1 to approximately 100° C., preferably from approximately 10 to approximately 50° and particularly preferably at ambient temperature.

The subsequent gelation of the sol is initiated by increasing the pH. For this purpose, a base is continuously added to the continuously produced pre-sol. Whereas the hydrolysis product has a pH of from approximately 1 to 2, said pH is increased to from approximately 2 to 3 by adding the silicic acid dispersion. However, it has been found that the tear resistance of the gel during shrinking can be further improved if the pH is further increased, for example to values in the range of from 3 to 9, preferably 4-6. The base may be for example ammonia (aqueous solution or gaseous), an organic amine compound or pyridine. Alkaline bases or alkaline earth bases are less preferred because they introduce additional cations into the product, which can be undesirable for producing highly pure quartz glass.

Reactors

Even if the choice of reactors is not critical in itself, one embodiment of the invention has, however, proven to be particularly advantageous: it is particularly preferable if at least one of the steps (a), (b) or (c) is carried out in a flow reactor, optionally with an upstream mixing element.

In the simplest embodiment, the reactors are tubes made of durable material, such as Teflon, polyamide, metal, polyethylene or polypropylene, that may have a length of from approximately 50 to approximately 1000 m, preferably from approximately 100 to approximately 800 m and particularly preferably 100-500 m and a cross section in the centre of from approximately 1 to approximately 10 mm, preferably from approximately 1 to approximately 5 mm. Said tubes may be wound up in a spiral, which considerably reduces the space required. The long distances correspond to the optimum reaction time in each case for a given flow rate. Arrangements of this kind are highly flexible, as the tube lengths can be lengthened or shortened as desired and can be cleaned with minimal effort. Carrying out the reaction in this way can significantly contribute to the profitability of the method.

Formation of Gel

The pre-sol is conveyed continuously out of the reactor R3, mixed with ammonia and filled into moulds in which the formation of gel can take place. As the aquagels obtained in this manner shrink in the mould during the ageing process, they must be able to slide in the container easily. For this reason, containers made of a hydrophobic material, such as polyethylene, polypropylene, Teflon, PVC or polystyrene, are particularly suitable.

For the purpose of processing, the aquagels must be removed from the moulds and dried to form xerogels. The aquagels may be removed from the moulds under specific conditions, for example underwater. In the case of larger aquagels, the ethanol can be partially replaced with water by remaining in water for a time. This makes it possible for larger aquagels (e.g. 8×8×8 cm) to dry without tears. Additionally, the water bath can also be used in order to allow various elements to diffuse into the aquagel. This makes coloured quartz glass possible, for example. The drying conditions are influenced by the evaporation speed of the solvent in the gel, i.e. water and alcohol. Reducing the evaporation speed while maintaining a low evaporation rate helps to prevent the gel from tearing. Long drying times, conversely, make the method more expensive, and therefore a compromise must be found.

Sintering Process

The sintering process can be carried out in a manner known per se. During the sintering process, the remaining solvents contained in the xerogels are removed and the pores in the system are closed. The sintering temperature is up to 1400° C. and can be carried out in a normal atmosphere for most products. According to the invention, the sintering process is carried out in the following manner:
1) Removing the solvent;
2) Removing optionally contained undesired organic compounds;
3) Closing the optionally available pores in order to form quartz glass.

In order to remove the solvents in partial step 1, temperatures of from approximately 20° C. to approximately 200° C. are used, preferably from approximately 70 to approximately 150° C. and particularly preferably from from approximately 90 to approximately 110° C. The removal of undesired organic compounds, which develop as a result of carbonaceous reactants/products decomposing, in step 2 is carried out at temperatures in the range of from approximately 800 to approximately 1100° C., preferably from approximately 850 to approximately 1050° C. and particularly preferably from approximately 900 to approximately 1000° C. In step 3, the pores are closed at temperatures of between approximately 1100 and approximately 1400° C., preferably from approximately 1150 to approximately 1350° C. and particularly preferably from approximately 1200 to approximately 1300° C.

### EXAMPLES

### Example 1

TEOS was provided through a first pump and aqueous HCl (0.010 mol/l) was provided through a second pump. Both feed materials had previously been degassed by ultrasonic treatment. The two solutions were guided through tubes and merged using a tee. The mixture had the following composition:

| | |
|---|---|
| TEOS | 66.66 vol. % |
| HCl | 33.33 vol. % |

Mixing occurred at 75° C. in a first PA tube (reactor R1) that had a length of 300 m and an inner diameter of 2.7 mm; the residence time in the tube was approximately 30 minutes. The pH was 1.5.

The OX 50 dispersion was produced in the second reactor by 500 g OX 50 being introduced into 1000 g water. The water had previously been degassed by ultrasonic treatment. An Ultra-Turrax® was used for homogenising the dispersion. The dispersion, having wOX 50 of 33.33%, obtained in this manner was then further transferred by means of a pump in the next step. The two flows were merged through an additional tee and continuously mixed by a static mixer tube, the pH being approximately 2.5. The pre-sol was then degassed with ultrasound. Aqueous ammonia was then continuously added to the pre-sol and the pH of the pre-sol was adjusted to 4-5, and the pre-sol was immediately filled into moulds made of PE (2×2×2 cm) and said moulds were sealed tightly. After approximately 10 seconds, gelation began. After a residence time of 20 hours in the sealed moulds, the aquagels were removed from the moulds underwater, and were air-dried to form xerogels after two hours in the water bath. The xerogels were then sintered to form quartz glass by means of the following temperature ramps: RT-100° C. (4 hours), 100° C. (3 hours), 100° C.-950° C. (4 hours), 950° C. (2 hours), 950° C-1250° C. (6 hours), 1250° C. (1 hour).

1. Continuous sol-gel method for producing quartz glass, comprising the following steps:
(a) continuously metering a silicon alkoxide into a first reactor (R1) and carrying out an at least partial hydrolysis process by adding an aqueous mineral acid, thereby obtaining a first product flow (A);
(b) continuously producing an aqueous silicic acid dispersion by continuously mixing water and silicic acid in a second reactor, thereby obtaining a second product flow (B);
(c) continuously mixing the product flows (A) and (B) from steps (a) and (b) in a third reactor (R3) in order to produce a pre-sol, thereby obtaining a third product flow (C);
(d) continuously adding an aqueous base to the product flow (C), thereby obtaining a sol;
(e) continuously filling the exiting sol from step (d) into moulds, thereby obtaining an aquagel;
(f) drying the aquagels from step (e), thereby obtaining xerogels;
(g) sintering the xerogels from step (f), thereby obtaining quartz glass, wherein at least one of the steps (a) to (e) additionally includes a degassing process of at least one feed material used in the step.

2. Method according to claim 1, characterised in that the degassing process is carried out by ultrasound, vacuum degassing, distillation, vacuum/freezing cycles, thermal degassing, chemical methods, removing gas by means of inert gas; adding deaerating additives and centrifugation or a combination of two or more of these measures.

3. Method according to claim 1, characterised in that in step (a), silicon alkoxides that follow the formula (I) are used
Si(OR)₄ (I)
in which R denotes an alkyl group having from 1 to 6 carbon atoms.

4. Method according to claim 1, characterised in that in step (a), tetraethyl orthosilicate (TEOS) is used as the silicon alkoxide.

5. Method according to claim 1, characterised in that in step (a), from approximately 1 to approximately 60 wt. % mineral acid is used based on the silicon alkoxides.

6. Method according to claim 1, characterised in that in step (a), the hydrolysis process of the silicon alkoxides is carried out at a temperature in the range of from approximately 1 to approximately 100° C.

7. Method according to claim 1, characterised in that in step (b), highly dispersive silicic acids are used that have BET surface areas in the range of from approximately 30 to approximately 100 m²/g.

8. Method according to claim 1, characterised in that in step (b), an aqueous dispersion is produced that contains from approximately 1 to approximately 60 wt. % silicic acid.

9. Method according to claim 1, characterised in that the product flows (A) and (B) are mixed in a volume ratio of alkoxide to silicic acid of from approximately 10:1 to approximately 1:10.

10. Method according to claim 1, characterised in that the product flows (A) and (B) are mixed at temperatures in a range of from approximately 0 to approximately 80° C.

11. Method according to claim 1, characterised in that a base is continuously added into the reactor (R3) to form a pre-sol.

12. Method according to claim 1, characterised in that at least one of the steps (a), (b) or (c) is carried out in a flow reactor, optionally with an upstream mixing element.

13. Method according to claim 12, characterised in that flow reactors are used that have a length of from approximately 50 to approximately 1000 m and a cross section of from approximately 1 to 10 mm.

14. Method according to claim 1, characterised in that the formation of gel is carried out at temperatures in the range of from 0 to 100° C.

15. Method according to claim 1, characterised in that drying is carried out at temperatures in the range of from 0 to 150° C.
